(19) United States
(12) Patent Application Publication
(10) Pub. No.: US 2025/0020266 A1
(43) Pub. Date: Jan. 16, 2025

(54) UNIVERSAL MULTI-PAD MOUNTING BRACKET ASSEMBLY

(71) Applicant: George Kell, Morris, OK (US)

(72) Inventor: George Kell, Morris, OK (US)

(21) Appl. No.: 18/769,981

(22) Filed: Jul. 11, 2024

Related U.S. Application Data
(60) Provisional application No. 63/513,008, filed on Jul. 11, 2023.

(51) Int. Cl. F16M 11/04; F16M 11/24; G10G 5/00

(52) U.S. Cl. CPC F16M 11/041; F16M 11/043; F16M 11/24; G10G 5/005

(57) ABSTRACT

A universal multi-pad mounting bracket is disclosed, including a mounting bracket attached to a module via a plurality of fasteners and a channel provided on a first side of the mounting bracket. A stand mount includes a left side and a right side to be received by the channel to slidingly engaged with the mounting bracket to the stand mount. A tube is positioned on a bottom side of the stand mount to slidingly engage with a stand.

### CROSS-REFERENCE TO RELATED APPLICATIONS

The present application claims priority to U.S. Provisional Application No. 63/513,008 filed Jul. 11, 2023, titled “QUICK RELEASE MULTIPAD BRACKET” which is hereby incorporated by reference in its entirety.

### TECHNICAL FIELD

The embodiments disclosed herein generally relate to mounting hardware for electronic devices and more specifically to quick release and universal brackets for mounting a multi-pad.

### BACKGROUND

Musicians utilize various instruments and devices when playing and recording music. These can include digital music modules which allow the musician to create sounds, control audio levels and settings, and perform various other tasks involved in the creation of music and controlling of music outputs. In particular, multi-pads are devices which play pre-recorded rhythmic and melodic sequences and may also allow the recorder to create their own content.

Current mounting hardware for multi-pad bracket holders require users to reach under the module, unscrew it, and lift it off the stand to remove the module. Musicians and recording engineers may spend considerable time trying to remove modules from stands or mounts, leaving little time for other equipment maintenance tasks.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a universal multi-pad mounting bracket, including a mounting bracket attached to a module via a plurality of fasteners and a channel provided on a first side of the mounting bracket. A stand mount includes a left side and a right side to be received by the channel to slidingly engaged with the mounting bracket to the stand mount. A tube is positioned on a bottom side of the stand mount to slidingly engage with a stand.

The universal multi-pad mounting bracket enables the user to easily attach a variety of multi-pads without the user having to remove the permanent mounting bracket. Users can keep the permanent bracket attached to a stand and slide the multi-pad on and off quickly without removing screws or the permanent mounting bracket. The mounting bracket forms a flat surface on the back of the music module (i.e., the multi-pad) allowing it to be easily stored in a protective case, without the need to remove the bracket prior to storage.

Prior devices required that the user unscrew the mounting bracket from the music module prior to its replacement and/or storage. This process can be difficult and requires significant time and energy when removing and/or replacing the music module from the stand.

In one aspect, the channel includes a first receiver positioned on a left side of the mounting bracket and a second receiver positioned on the right side of the mounting bracket.

In one aspect, the first side of the mounting bracket forms a first planar surface.

In one aspect, a top side of the stand mount forms a second planar surface, and wherein the first planar surface and the second planar surface contact one another once the stand mount is slidingly engaged to the mounting bracket.

In one aspect, the channel further comprises a third receiver position on a rear side of the mounting bracket to prevent the stand mount from sliding through the channel.

In one aspect, the stand is an adjustable stand to enable the selection of a height of the module.

In one aspect, the mounting bracket is flat and is attached on a bottom side of the module to facilitate storage of the module with the attached mounting bracket.

In one aspect, the stand mount includes one or more hinges to enable the adjustment of the position of the mounting bracket.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the universal multi-pad mounting bracket including the mounting plate and stand mount, according to some embodiments;

FIG. 2 illustrates a perspective view of the universal multi-pad mounting bracket including the mounting plate slidingly engaged with the stand mount, according to some embodiments;

FIG. 3 illustrates a perspective view of the universal multi-pad mounting bracket including the mounting plate slidingly engaged with the stand mount, according to some embodiments;

FIG. 4 illustrates a perspective view of the universal multi-pad mounting bracket attached to a stand, according to some embodiments;

FIG. 5 illustrates a perspective view of a module attached to the universal multi-pad mounting bracket, according to some embodiments;

FIG. 6 illustrates a perspective view of the universal multi-pad mounting bracket attached to a stand, wherein the module has been removed from the stand mount, according to some embodiments; and

FIG. 7 illustrates a perspective view of the universal multi-pad mounting bracket having an adjustable mount, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a universal multi-pad mounting bracket (which may be referred to herein as “device” or “the device”) having a quick release attachment mechanism. The universal multi-pad mounting bracket is capable of slidingly engaging with various multi-pad holders without the user having to remove the permanent mounting bracket. Users can keep the permanent bracket attached to a stand and slide the multi-pad on and off quickly without removing screws or the permanent mounting bracket.

One skilled in the arts will readily understand that while the example of a multi-pad is used herein by way of example, the universal bracket may be used for various types of music modules which are connected to a stand or other holding device. Therefore, the disclosure provided herein should not be restricted to use for multi-pads, but rather various music modules known in the arts.

As used herein, the term “module” or “music module” relates to any digital music module known in the arts including a multi-pad (used as the primary embodiments and example).

The universal multi-pad mounting bracket screws onto the modules via a plurality of screws (for example, 4 screws). And may be constructed using plastic, metal, or another suitable material. During use, the user may slide the universal multi-pad mounting bracket onto and off of the tube mounting bracket that is fastened to the module. The user may then remove the current tube bracket from the module, then fasten the universal multi-pad mounting plate to the module. The industry-standard mount may then be applied which enables the user to slide the universal multi-pad mounting plate thereon. The mounts are configured to attached to a stand, enabling the universal multi-pad mounting bracket to remain attached to the stand, while the module is slid on and off of the universal multi-pad mounting bracket.

The device provides user with a universal quick release multi-pad bracket capable of being applied to various music-related modules. The device allows users to keep the permanent bracket attached to a stand. The multi-pad can be easily and efficiently slid on an off of the permanent bracket without the user having to undo the screws or the permanent bracket.

The device is capable of functioning with multiple currently available modules and offers a universal fit for ease and convenience.

In some embodiments, the device enables users to place modules in a flat position in a case, such that the user does not need to purchase specific cases to accommodate each mounting bracket.

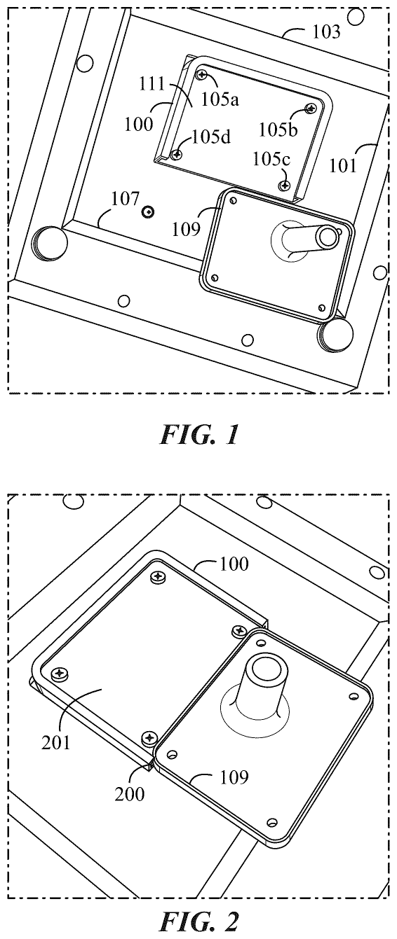

FIG. 1 illustrates the universal multi-pad mounting bracket assembly wherein the mounting bracket 100 is attached to a module 101 (e.g., a multi-pad 103) using a plurality of fasteners 105a, 105b, 105c, 105d to form a first planar surface 111. The mounting bracket 100 is attached to the bottom 107 of the module 101 such that when mounted, the top of the module 101 faces upwards towards the user. The multi-pad bracket assembly also includes a stand mount 109 which slidingly engages with the mounting bracket 100 to enable the user to easily slide the module 101 on to and off of the stand or other mounting item.

FIG. 2 illustrates the universal multi-pad mounting bracket assembly having the mounting bracket 100 disconnected from the stand mount 109. The mounting bracket 100 includes a channel 200 positioned on the first side 201 of the mounting bracket 100. The first side 201 is arranged such that it can engage with the stand mount 109 and faces towards the stand or other mounting item.

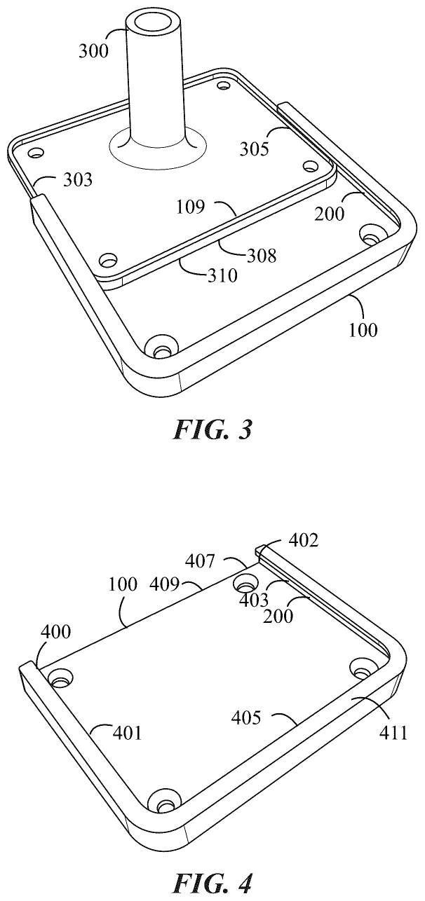

FIG. 3 illustrates the stand mount 109 being partially engaged with the mounting bracket 100. The stand mount 109 includes a left side 303 and a right side 305 which slidingly engage with the channel 200 such that the module can be easily removed once the mounting bracket 100 is attached thereto. The stand mount 109 includes a tube 300 which connected to a stand or other item to which the music module is mounted to. The top side 308 of the stand mount 109 forms a second planar surface 310 which is in the same plane as the first planar surface of the mounting bracket 100.

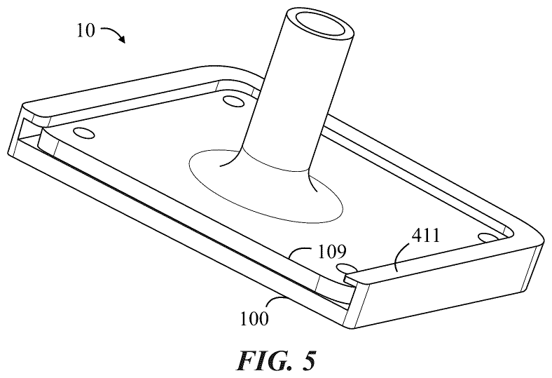

FIG. 4 illustrates the universal multi-pad mounting bracket assembly including the mounting bracket 100 being disengaged from the music module for clarity. The mounting bracket 100 includes a channel 200 having a first receiver 400 positioned on the left side 401, a second receiver positioned 402 on the right side 403, a rear side 405 and an opening 407 positioned at the front side 409. The opening 407 is dimensioned to receive the stand mount 109 (see FIG. 3) such that the stand mount 109 can be slidingly engaged and retained in position via the channel 200. The channel 109 includes a top edge 411 extending around each side 401,403,405 of the channel 200. The top edge 411 extends partially over the surface of the stand mount such that it is retained on the mounting bracket 100. FIG. 5 illustrates the universal multi-pad mounting bracket assembly 10 including the stand mount 109 being fully engaged with the mounting bracket 100. As described above, the top edge 411 is retains the stand mount 109 within the mounting bracket 100.

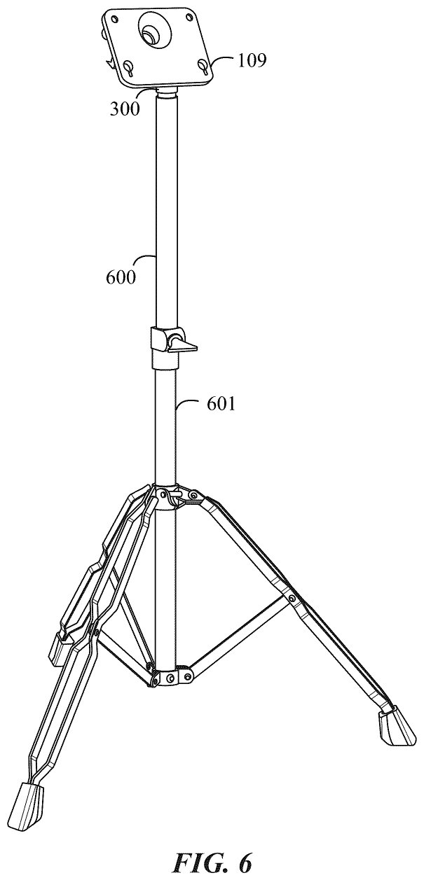

FIG. 6 illustrates the stand mount 109 attached to the stand 600. The stand 600 may be an adjustable stand 601 as illustrated in the current embodiment or may be another mounting item which holds the stand mount 109 and selected music module having a mounting bracket attached thereto. The tube 300 (see FIGS. 1-3 and FIG. 5) is slidingly engaged or otherwise connected to the stand 600 such that the music module and attached mounting bracket can be easily slid off the stand mount 109 and connected stand 600.

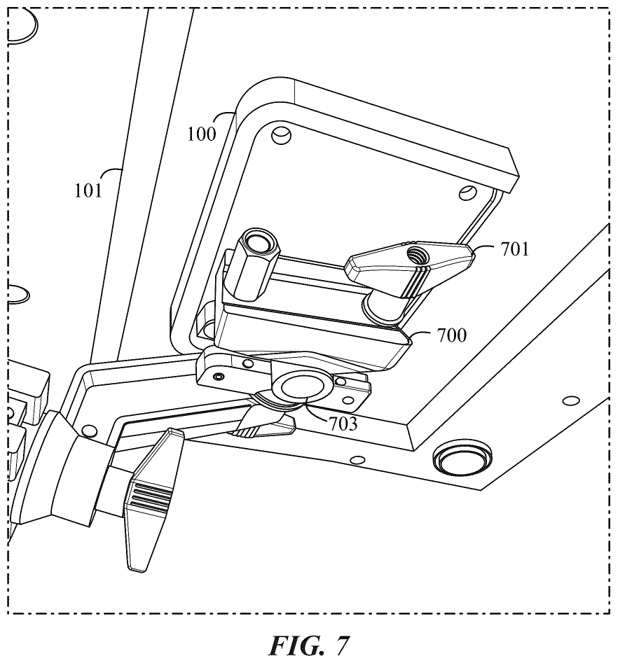

FIG. 7 illustrates a perspective view of an adjustable universal multi-pad mounting bracket assembly 10 including an adjustable mount 700 which allows the orientation of the mounting bracket 100 to adjust the orientation of the module 101 during use. The adjustable mount 700 can be pivoted in various directions for convenience when using the module. The adjustable mount 700 may include a locking mechanism 701 which retains the adjustable mount 700 in a fixed position. This allows the user to loosen the locking mechanism 701 and adjust the orientation of the adjustable mount to re-orient the module. Once the user has re-oriented the module to a position they prefer, the locking mechanism is re-arranged, and the module is held in the desired orientation. The adjustable mount 700 may include one or more hinges 703 or other means of pivoting the adjustable mount 700 into the desired position.

In some embodiments, the universal multi-pad mounting bracket may be constructed of various material including metals, metal alloys, plastics, and other sufficiently rigid materials which are capable of holding the module in a fixed position on top of the stand or other mounting item.

In some embodiments, the locking mechanism 701 may be a friction-fit mechanism such that the locking mechanism 701 can be selectively tightened and loosened.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A universal multi-pad mounting bracket, comprising:
a mounting bracket attached to a module via a plurality of fasteners;
a channel provided on a first side of the mounting bracket;
a stand mount including a left side and a right side, the left and right sides to be received by the channel to slidingly engaged with the mounting bracket to the stand mount; and
a tube positioned on a bottom side of the stand mount, the tube to slidingly engage with a stand.

2. The universal multi-pad mounting bracket of claim 1, wherein the channel includes a first receiver positioned on a left side of the mounting bracket and a second receiver positioned on the right side of the mounting bracket.

3. The universal multi-pad mounting bracket of claim 1, wherein the first side of the mounting bracket forms a first planar surface.

4. The universal multi-pad mounting bracket of claim 3, wherein a top side of the stand mount forms a second planar surface, and wherein the first planar surface and the second planar surface contact one another once the stand mount is slidingly engaged to the mounting bracket.

5. The universal multi-pad mounting bracket of claim 1, wherein the channel further comprises a third receiver position on a rear side of the mounting bracket to prevent the stand mount from sliding through the channel.

6. The universal multi-pad mounting bracket of claim 1, wherein the stand is an adjustable stand to enable the selection of a height of the module.

7. The universal multi-pad mounting bracket of claim 1, wherein the mounting bracket is flat and is attached on a bottom side of the module to facilitate storage of the module with the attached mounting bracket.

8. The universal multi-pad mounting bracket of claim 7, wherein the stand mount includes one or more hinges to enable the adjustment of the position of the mounting bracket.

9. A universal multi-pad mounting bracket assembly, comprising:
a mounting bracket attached to a module via a plurality of fasteners to form a substantially flat surface;
a channel provided on a first side of the mounting bracket;
a stand mount including a left side and a right side, the left and right sides to be received by the channel to slidingly engaged with the mounting bracket to the stand mount;
a tube positioned on a bottom side of the stand mount, the tube to slidingly engage with a stand,
wherein the stand mount is retained on the stand to enable a user to efficiently remove and replace the module on the stand.

10. The universal multi-pad mounting bracket of claim 9, wherein the channel includes a first receiver positioned on a left side of the mounting bracket and a second receiver positioned on the right side of the mounting bracket.

11. The universal multi-pad mounting bracket of claim 10, wherein the first side of the mounting bracket forms a first planar surface defining the substantially flat surface.

12. The universal multi-pad mounting bracket of claim 11, wherein a top side of the stand mount forms a second planar surface, and wherein the first planar surface and the second planar surface contact one another once the stand mount is slidingly engaged to the mounting bracket.

13. The universal multi-pad mounting bracket of claim 12, wherein the channel further comprises a third receiver position on a rear side of the mounting bracket to prevent the stand mount from sliding through the channel.

14. The universal multi-pad mounting bracket of claim 13, wherein the stand is an adjustable stand to enable the selection of a height of the module.

15. The universal multi-pad mounting bracket of claim 14, wherein the mounting bracket is substantially flat and is attached on a bottom side of the module to facilitate storage of the module with the attached mounting bracket.

16. The universal multi-pad mounting bracket of claim 15, wherein the stand mount includes one or more hinges to enable the adjustment of the position of the mounting bracket.

17. The universal multi-pad mounting bracket of claim 16, wherein the one or more hinges enable the user to pivot the module on the stand to a suitable position.

18. The universal multi-pad mounting bracket of claim 17, wherein the substantially flat surface formed by the mounting bracket attached to the module enables storage in a universal protective case.

19. The universal multi-pad mounting bracket of claim 18, wherein the tube is retained on the stand via a friction fit mechanism.

20. A universal multi-pad mounting bracket assembly, comprising:
a universal mounting bracket attached to a back side of a module via a plurality of fasteners to form a substantially flat surface facilitating storage of the mounting bracket and the attached module;
a channel provided on a first side of the mounting bracket, the channel to connect with a stand mount to enable the efficient connection and disconnection of the module to an adjustable stand;
a tube positioned on a bottom side of the stand mount, the tube to slidingly engage with a stand to retain the module on the stand; and
wherein the channel enables the efficient switching between multiple modules without removing the universal mounting bracket.
